(19) United States
(12) Patent Application Publication
(10) Pub. No.: US 2026/0142825 A1
(43) Pub. Date: May 21, 2026

(54) Authenticating a Device

(71) Applicant: Dabco Limited, Newbury (GB)

(72) Inventor: Nils Poschke, London (GB)

(21) Appl. No.: 18/705,836

(22) PCT Filed: Oct. 17, 2022
(86) PCT No.: PCT/GB2022/052629

§ 371 Date: Apr. 29, 2024

(30) Foreign Application Priority Data
Nov. 3, 2021 (GB) 2115815.9

(51) Int. Cl. H04L 9/32

(52) U.S. Cl. CPC H04L 9/3234

(57) ABSTRACT

Method and system for authenticating a device, comprising receiving, at a node of a distributed ledger, from the device an authentication request, the authentication request including data indicating one or more steps of an authentication method. Authenticating the device across a plurality of nodes of the distributed ledger, wherein each of the plurality of nodes follows the one or more steps indicated by the data received from the device.

### FIELD OF THE INVENTION

The present invention relates to a system and method for authenticating devices, and in particular for authentication devices within a distributed system using blockchain technology.

### BACKGROUND OF THE INVENTION

There is a common need for different entities to interact and transact with each other to exchange value or for other purposes. However, for this to be done in a safe and secure manner for each party to a transaction, a level of trust is required to exist between transacting entities. In the absence of such trust, other structures and procedures are necessary such as enforceable contracts and third party authorities or intermediaries.

Secure authentication between different entities enables safe interaction between otherwise remote or unrelated parties. For example, SIMs may be pre-loaded with individual keys known to an issuing authority. The issuing authority can securely share these individual (symmetric) keys with the owner of the SIM. The SIMs do not allow these keys to be copied and so when a device having a particular SIM communicates with the owner (or a system under control of the owner) then the owner can be sure of the identity of the device and secure communications can be established. This system is effective in telecommunications communications when is it convenient and efficient to distributed physical SIMS to devices.

For shorter-lived interactions requiring secure communications, key material can be shared and verified using trusted intermediaries like certificate authorities. However, this require the establishment of such trusted intermediaries, which is not always efficient or desirable and also can introduce latency.

Furthermore, different device types with different security and authentication capabilities may need to authenticate with a variety of entities for different purposes. This can create additional system complexities or require comprises in security.

Therefore, there is required a method and system that overcomes these problems.

### SUMMARY OF THE INVENTION

Devices, such as mobile device, low-powered items or other components, can have access to and be capable of different authentication protocols and methods. Individual devices may have the ability to use multiple authentication methods or be limited to a single method. In some example implementations, a device can be updated with a different authentication method or certain available authentication methods can be deactivated and activated at different times. When a device requires authentication with a particular system or service, the device generates an authentication request. The request includes information or data defining or describing the particular authentication method that is to be used. Different devices can generate requests with different authentication methods (or defining one or more steps of an authentication method).

A distributed ledger (or a single node of a distributed ledger) receives these requests from one or more devices. Because the request includes information identifying or describing the authentication method or steps to use then it can receive such requests from devices capable of different authentication methods. The nodes of the distributed ledger attempt to authenticate the device using the authentication method described or referenced in each request. Preferably, the request that includes details of or identifies the authentication method also includes credentials or cryptographic material used to authenticate the device according to the authentication method. Advantageously, the information describing or identifying the authentication method is included in a header of the request and the cryptographic material in included within a payload or body of the request but other formats can be used.

Each device may be registered in advanced or issue a request for authentication without being registered. However, registering in advance can provide additional performance and security enhancements because advanced preparation can be made for handling the requests.

In accordance with a first aspect there is provided a method for authenticating a device, the method comprising the steps of:
receiving, at a node of a distributed ledger, from the device an authentication request, the authentication request including data indicating one or more steps of an authentication method; and
authenticating the device across a plurality of nodes of the distributed ledger, wherein each of the plurality of nodes follows the one or more steps indicated by the data received from the device. Therefore, authentication of different devices using different authentication protocols can be processed and authentication using the same distributed ledger. Therefore, different devices using different authentication methods can be more easily authenticated with the same system or systems.

Preferably, the request may further include credentials and the step of authenticating the device across the plurality of nodes of the distributed ledger may further includes authenticating the credentials. For example a payload within the request can be signed with a private key that is only known by the device (or UICC or SIM of the device). In another example, the request can contain tokens that are encrypted with a symmetric key. This can provide seeds for the authentication to be carried out by the nodes of the distributed ledger.

Optionally, the authentication of the device may be unsuccessful unless more than one node of the plurality of nodes authenticate the device according to the one or more steps indicated by the data received from the device. Therefore, security can be increased as more than one node has to successfully confirm authentication.

Optionally, authentication of the device may be unsuccessful unless a majority of the plurality of nodes involved in the authentication authenticate the device. Therefore, security can be increased as more than one node has to confirm authentication. A minority of the nodes involved in the authentication may fail authentication for different reasons (e.g. fail to complete, timeout, etc.) and authentication can be successful in a majority of nodes complete authentication. In some example implementations, all of the nodes will be involved in authentication. In this case, the majority of nodes must individually authenticate the device for the overall authentication to be successful. In other example implementations, there may only be a subset of the nodes required to attempt authentication. Therefore, it is only a majority of this subset that is required for overall successful authentication of the device.

Preferably, wherein the data indicating one or more steps of an authentication method may be included in a header of the request. The request may contain a header with the authentication method details and a payload containing credentials or other cryptographic material used in the authentication carried out by the nodes, for example.

Optionally, the indication of the one or more steps of an authentication method indicates an authentication protocol of a plurality of possible or alternative authentication protocols. For example, the indication may include an identifier of a particular authentication method to use. There may be several different authentication protocols that are available to the device and the data indicates within the request which one to use for a particular authentication. A device may only be able to authenticate using a single authentication method. Again, the data may indicate a particular authentication method to use with that device. Different devices or groups of devices may use different authentication methods.

Optionally, the plurality of authentication protocols may include: symmetric encryption; asymmetric encryption; public key infrastructure, PKI; SIM Trust; IoT SAFE; TLS; DTLS; and Generic Bootstrapping Architecture, GBA. Other authentication methods or protocols may be used.

Optionally, the method may further comprise the step of the device selecting the authentication method from a plurality of authentication methods available to the device before generating the request including data indicating the one or more steps of the selected authentication method. Therefore, the device can control which authentication method it uses for each particular system or purpose. The device may receive in advance an instruction to use a particular authentication method under different circumstances or for use with different systems.

In accordance with a second aspect, there is provided an authentication system comprising:
one or more devices, wherein each of the one or more devices is configured to generate an authentication request, the authentication request including data indicating one or more steps of an authentication method; and
a distributed ledger having a plurality of nodes, wherein each of the plurality of nodes is configured to:
   receive from one of the devices an authentication request indicating the one or more steps of the authentication method; and
   authenticate the device following the one or more steps indicated by the data received from the device.
Advantageously, a further device of the one or more devices may be configured to generate a further authentication request indicating further one or more steps of a second authentication method different to the one or more steps of the authentication method. Therefore, any number of different devices (or devices or different or the same types) can each use a different authentication method with the same distributed ledger.

Optionally, the authentication of the device may be unsuccessful unless more than one node of the plurality of nodes authenticates the device according to the one or more steps indicated by the data received from the device.

Optionally, each of the one or more devices may be further configured to select the authentication method from a plurality of authentication methods available to the device before generating the request including data indicating the one or more steps of the selected authentication method.

Advantageously, each of the one or more devices may be further configured to receive data defining a new authentication method for use in further authentication requests. Therefore, devices may change the authentication method or methods (or method steps) that they use. This adds flexibility and allows devices to continue to work with new or improved authentication methods with limited reconfiguration. The new authentication method definition may be received from the one or more nodes of the distributed ledger or from another entity or server, for example.

Preferably, the original and/or new authentication method may have an expiry time. Therefore, security may be improved by refreshing the authentication method at intervals or after predetermined or configured duration.

Preferably, the one or more devices further comprises a UICC or SIM configured to secure the request. Alternatively, other techniques may be used to secure the request and/or generate cryptographic material used by the defined authentication method.

In accordance with a third aspect, there is a provided and authentication method and system that incorporates the steps of registration followed by the steps of any or all of the authentication methods described above. Registration may include determining from the device or attributes of the device what authentication method or methods it is capable of and enabling the device to use this information to generate the requests (including the data indicating one or more steps of an authentication method).

The methods described above may be implemented as a computer program comprising program instructions to operate a computer. The computer program may be stored on a computer-readable medium.

The computer system may include a processor or processors (e.g. local, virtual or cloud-based) such as a Central Processing unit (CPU), and/or a single or a collection of Graphics Processing Units (GPUs). The processor may execute logic in the form of a software program. The computer system may include a memory including volatile and non-volatile storage medium. A computer-readable medium may be included to store the logic or program instructions. The different parts of the system may be connected using a network (e.g. wireless networks and wired networks). The computer system may include one or more interfaces. The computer system may contain a suitable operating system such as UNIX, Windows (RTM) or Linux, for example.

It should be noted that any feature described above may be used with any particular aspect or embodiment of the invention.

### BRIEF DESCRIPTION OF THE FIGURES

The present invention may be put into practice in a number of ways and embodiments will now be described by way of example only and with reference to the accompanying drawings, in which:

FIG. 1 shows a flowchart of a method for authenticating a device;

FIG. 2 shows a schematic diagram of a system and data flow for registering one or more devices for use with the method of authentication of FIG. 1;

FIG. 3 shows a schematic diagram of the system and data flow for authenticating one or more devices, including an authentication request; and

FIG. 4 shows a schematic diagram of the authentication request of FIG. 4.

It should be noted that the figures are illustrated for simplicity and are not necessarily drawn to scale. Like features are provided with the same reference numerals.

### DETAILED DESCRIPTION OF THE PREFERRED EMBODIMENTS

The ‘Internet of Things’ is growing and transitioning to an ‘Economy of Things’ (EoT). The number of IoT devices is growing and generating large volumes of data. IoT devices and smart services interact and interoperate across ownership domains and offers the potential to support data and smart service value transactions automatically in near real time. This can improve interoperability and functionality.

The ‘Economy of Things’ requires the capability for devices/services to identify, trust each other, and where required automatically transact value directly or using peer-to-peer functionality. There are a range of technologies ranging from Distributed Ledger, Secure Elements, Cryptography and Device Wallets which support Digital ID, Federated Security and transaction applications and services needed for IoT, but they are fragmented, have high costs and not sufficiently scalable.

Technology underlying distributed cryptocurrencies, such as distributed ledgers, can also be used to record other types of transactions and can form a verifiable history of exchanges or other forms of data without requiring trust to exist between entities. Distributed ledgers, such as blockchains, enable transactions, exchanges of value and verifiable event recording to occur in the absence of trust. This requires the use of blockchains to form a consensus between nodes of a distributed ledger that is difficult to corrupt or control by any individual actor or entity. This usually takes the form of a race to consensus based on a proof of work.

Individual devices require authentication with different systems and for different reasons. These systems may include telecommunications systems, service providers, computer networks or other types. The devices may also require authentication with distributed networks in order to access services. A system may provide services using a distributed system. Advantageously, the same distributed system that provides the services can also carry out authentication of individual devices. The use of a distributed ledger to authenticate devices removes the requirement for a trusted entity such as a certificate authority (CA). This is because multiple nodes of a distributed system (e.g. a distributed ledger) may be required before authentication of a device is successful. For example, authentication of device does not occur until more than one or a majority of nodes each individually authenticate the device. This substantially reduces the risk of corrupting a single certifying authority.

In order to enable different devices to use different security protocols or authentication methods, information or data that is received from each device as a request for authentication includes data indicating one or more steps of an authentication method. This may be contained within a crypto header of a request and the request may also include information to authenticate the device ID using the specified authentication method. This crypto header can contain cryptographic nonces, e.g. tokens that are signed with a private key that is only known by the device or encrypted with a symmetric key which is shared with the distributed ledger, for example.

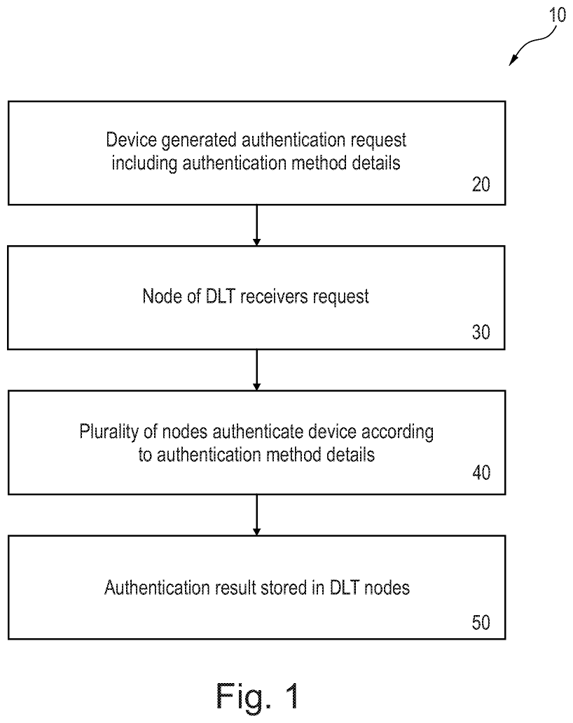

FIG. 1 shows a flow chart of a method 10 for performing authentication of a device using this system. At step 20, the device generates an authentication request. This may be at initial power-on or at another time. Included in the request are data or information including, describing or otherwise defining or identifying an authentication method (e.g. a recipe of the authentication method).

The device sends this request to the system (e.g. to a node of the distributed ledger). This may be a direct communication between the device and the node or via an indirect route (e.g. over a telecommunications network). At step 30 the node of the distributed ledger receives the request from the device.

The request is distributed to one or more other nodes of the distributed ledger. The nodes in receipt of this request attempt to authenticate the device using the particular authentication method defined by the data within the request. The nodes may already have access to the particular authentication method (e.g. a particular security protocol) or may receive software or parameters enabling the node to carry out the particular requested authentication method. This may be received from a different entity, for example, but based on the data indicating the authentication steps within the request.

Authentication of the device requires at least two of the nodes to successfully authenticate the device according to the defined authentication method or method steps. In particular example implementations, a minimum number of nodes must authenticate the device for overall authentication to be successful. In other example, a majority of nodes must authenticate the device for device authentication to be successful. The request may define such criteria or this may be predetermined (or be set by a customer backend). Therefore, security can be enhanced according to requirements. Success may be indicated by the process of adding a block to a blockchain and this blockchain becoming the definitive next block throughout the nodes of the distributed ledger. A service may be provided once the success-indicating block is added, for example.

In this example implementation, step 50 stores the result of authentication (success or failure) within the same distributed network (i.e. across the nodes). In other examples, success of the device authentication may take other forms (e.g. a particular service is provided).

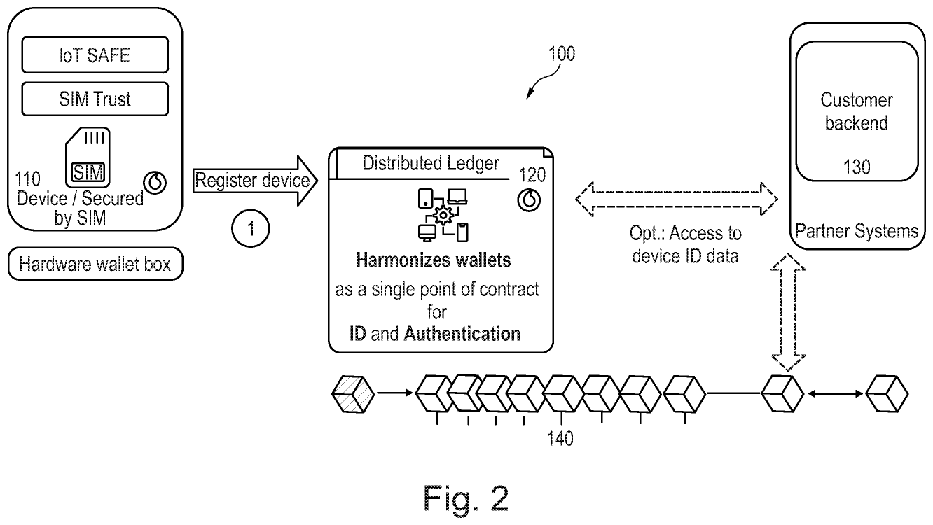

Therefore, the system (including the distributed ledger) can provide “Authentication as a Service”. Each device may be able to install a software development kit (SDK) that triggers the registration request at the distributed ledger (or at least at one node of the distributed ledger) at the time of first power-on or at another time. FIG. 2 shows the data flow within the system 100 used to register or setup a device to enable it to use or to carry out the method 10.

Registering the device may include determining attributes of the device and what authentication methods are available to the device (or what it is capable of). The registration process may also include a description of the hardware of the device (e.g. modem, SIM, hardware security module, etc.). Therefore, registration may add to the device the details of the authentication method (to be used in future). This particular authentication method (or steps involved in the method) may be based on the device attributes (e.g. hardware). Following registration, the device can generate future authentication requests that include data defining this particular authentication method. In other words, pre-registration enables the device to send out request for authentication methods that it is capable of without the device having to determine these methods itself. This can be useful when new authentication methods are defined and rolled out. Re-registration of the device can obtain or enable new authentication methods conveniently.

For example, when a device registers with the system or a particular service of the system, attributes of the device may be determined. This may be explicit with the device issuing a request for registration including its particular attributes or these may be inferred from the request for registration. The request may take that form that implies the presence of a SIM and the communication format of the request may indicate that the SIM has a particular SDK (or other processing logic) installed.

The device 110 may have any one or more of different security capabilities. FIG. 2 shows the device 110 having a SIM (or UICC) and IoT SAFE and SIM Trust capabilities. However, devices may have either, both or none of these capabilities. IoT SAFE is an example of security technology that uses a SIM applet to provide end-to-end secure communications. IoT SAFE may carry out defined operations according to the GSMA standard using pre-shared keys stored on the SIM. SIM Trust is based on 3GPP Generic Bootstrapping Architecture (GBA) and can provision new keys as required. Either or both security architectures may be used with a particular device.

A secure element on a SIM (which may have standardised interfaces and carry out defined operations according to the IoT SAFE standard-GSMA) may be used to create one or more multiple sets of asymmetric keys inside a HSM (PKI on SIM) to provide the SIM (and with it the device) with a unique and immutable identity.

IoT SAFE may also be used to create a secure channel ((D)TLS) between the device and an IoT backend. This uses a secure element on the SIM to hold the asymmetric keys that are needed for the (D)TLS connection, but these keys may be used for other purposes.

At a high level the main difference between these two mechanisms lies in the cryptographic approach. The IoT SAFE Applet uses a secure element on the SIM to store and manage keys predominantly for asymmetric encryption (also known as Public Key Infrastructure, PKI) with public and private key pairs being generated and stored. In the GBA (e.g. SIM Trust) approach mobile network capabilities are used to establish a symmetric encryption between SIM and an endpoint (e.g. a server such as a DAB server).

Asymmetric encryption or PKI is the technology that is used by many IT infrastructures to secure https and other connections between servers using public/private key pairs. It is these cryptographic materials that can be used by the device of authenticating with various systems upon request (from the device).

The distributed ledger 120 is shown in FIG. 2 as receiving the request (“registering device” in this example) at step 1. Inside the distributed ledger 120 (e.g., within an SDK of the one or more nodes of the distributed ledger 120) there is a detection of which particular authentication method may be used and supported by the device. This may be derived from an explicit definition within the request for registration or determined from a combination of device (e.g., device type), modem, SIM (e.g., identifier or type) and any other hardware or attributes. However, this information may also be determined from the received request.

For example, the follow scenarios may be encountered and determined by the node from the request for registration:
1) If the device 110 carries a SIM with an IoT SAFE applet (providing PKI on secure element on the SIM), the authentication method or method steps chosen for this device is “IoT SAFE”;
2) If the device and modem and SIM have access to an IoT SIM Trust APN but the SIM does not carry the IoT SAFE SIM Applet, the authentication method or method steps, “SIM Trust” is chosen.
3) If no SIM is available (or not present), then the device needs to carry a hardware (HW) secure element or other secure mechanism. In this case the authentication method is determined as “secure element without SIM”.
4) Future authentication methods may be based on network authentication (like PCRF), for example.

During this detection or determining phase the SDK (or other processing logic) within each node of the distributed ledger 120 configures itself automatically and uses the chosen authentication method to generate cryptographic information (e.g., extract a public key from the PKI on the SIM in example 1 described above). If more than one authentication method is available (e.g., the device has access to IoT SAFE and SIM Trust), then a selection may be made by the node and/or the device 110. Preferably, the most secure combination is chosen, as defined by preconfigured rules or attributes within the SDK (either or both at the device 110 or node). Furthermore, a device developer who uses the SDK can manually override the preconfigured authentication method if more than one is available to the device (e.g., the request can define the authentication method steps to use).

Once the authentication method is chosen (selected, inferred or instructed), the registration of the device 110 against the distributed ledger 120 “authentication as a service” procedure may be automatically started on the next power-on of the device 110. This registration leads to populating data within the nodes of the distributed ledger 120 and can be used to generate a reliable digital identifier of the device 110. In some examples, cryptographic material associated with the device 110 may be stored within the nodes of the distributed ledger 120. (e.g., the device's IoT SAFE public key, SIM Trust symmetric key, etc.). This storage is not done centrally (like on a classic CA) but decentrally, using the distributed ledger technology. This enables a higher level of security as there is no single point of failure but more than one node caring for the authenticity of the cryptographic proof.

When the device 110 then sends data to a customer backend 130 or another device or entity, the data stream contains a crypto header that is describing the required authentication method and provides a “recipe” for the distributed ledger to prove the data's authenticity according to the method 10 described with reference to FIG. 1.

As a simple example the payload can be signed with a private key that is only known by the device 110 and the SIM or can contain tokens that are encrypted with a symmetric key. These seeds for authentication (or other cryptographic material) can be shared with the distributed ledger 120 during registration (see FIG. 2).

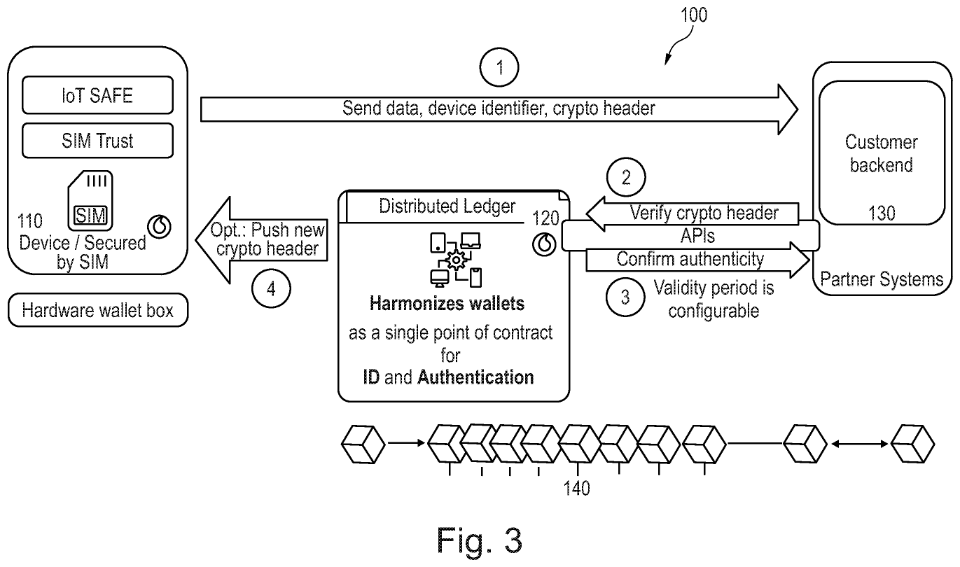

FIG. 3 shows an example flow of data used to implement the method 10 described with reference to FIG. 1. A customer backend 130 or other entity that requires authentication of devices 110 may verify a crypto header received from a particular device 110 with a node of the distributed ledger 120. This is shown as step 2 in FIG. 3 and may be achieved using an application programming interface (API) or by direct blockchain integration. This is different to classical centralised CAs, as the decentralized ledger is used for verification of these data. In this example, the request received from the device 110 for authentication is passed through the customer backed 130 and on to the nodes of the distributed ledger 120. More than one node on the distributed ledger 120 verifies whether the sender's cryptographic proof is authentic according to the particular authentication method steps defined or determined from information within the request (e.g. with the crypto header).

If the check is successful, i.e., the cryptographic information is reliable and optionally the device ID relates to a pre-registered device 110 and stored within the distributed ledger 120, then the nodes of the distributed ledger 120 each carry out the defined authentication method steps on the cryptographic material received with the request. Upon success of these individual authentications (carried out within the nodes), the distributed ledger confirms the authenticity of the device and the data received within the request (step 3 in FIG. 3).

Optionally, the distributed ledger 120 may push a new authentication input to the device 110, in case that the cryptographic information needs to be turned around or refreshed frequently for the sake of increased security (step 4 in FIG. 3). This mechanism can also be used for lifecycle management of the cryptographic information (e.g., certificate revocation or update).

This system 100 and method therefore unifies authentication methods across different device types and enables authenticity checks across architectures with increased simplicity.

The partner systems 140 shown FIGS. 2 and 3 may include payment systems or other systems that provide services to the device 110 and/or the customer backend 130.

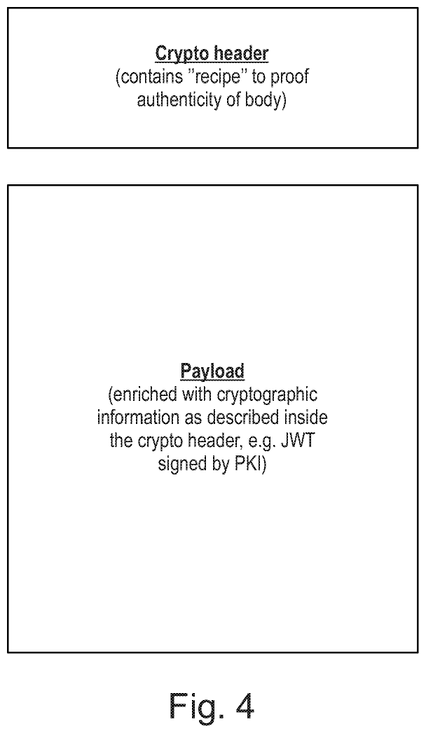

FIG. 4 shows high level details of an example request sent by the device 110 to the customer backed 130. This request includes a crypto header (describing the authentication method steps) and a payload including any necessary cryptographic material.

As will be appreciated by the skilled person, details of the above embodiment may be varied without departing from the scope of the present invention, as defined by the appended claims.

For example, devices without SIMs or hardware security elements may also utilise this method. Different registration procedures may be used (or devices may use the method 10 without any pre-registration at all). In this case, the request may contain additional data (e.g., identification data), for example. Although the figures show only one device, the system and methods may be used with a plurality of devices of the same or different types and capabilities. A plurality of customer backends may be present and configured in a similar or different way. Furthermore, whilst a customer backend has been described in the examples, this may be a different external entity or another node of the distributed ledger, for example. The data indicating one or more steps of an authentication method may provide a direct indication (e.g., describe these steps) or may take the form of an indirect instruction (e.g., providing an identifier of such methods or method steps). The data may also be a pointer or reference to a database entry (e.g., within the distributed ledger or elsewhere, for example). The services provided may include parking, access to a location, electricity of other utilities, telecommunication services, payments, data access, etc. Authentication may be provided automatically and without user intervention (e.g., when a vehicle approaches a toll-road or car park).

Many combinations, modifications, or alterations to the features of the above embodiments will be readily apparent to the skilled person and are intended to form part of the invention. Any of the features described specifically relating to one embodiment or example may be used in any other embodiment by making the appropriate changes.

1. A method for authenticating a device, the method comprising the steps of:
receiving, at a node of a distributed ledger, from the device an authentication request, the authentication request including data indicating one or more steps of an authentication method; and
authenticating the device across a plurality of nodes of the distributed ledger, wherein each of the plurality of nodes follows the one or more steps indicated by the data received from the device.

2. The method of claim 1, wherein the request further includes credentials and the step of authenticating the device across the plurality of nodes of the distributed ledger further includes authenticating the credentials.

3. The method according to claim 1 or claim 2, wherein authentication of the device is unsuccessful unless more than one node of the plurality of nodes authenticate the device according to the one or more steps indicated by the data received from the device.

4. The method according to any previous claim, wherein authentication of the device is unsuccessful unless a majority of the plurality of nodes involved in the authentication authenticate the device.

5. The method according to any previous claim, wherein the data indicating one or more steps of an authentication method are included in a header of the request.

6. The method according to any previous claim, wherein one or more steps of an authentication method indicate an authentication protocol of a plurality of authentication protocols.

7. The method of claim 6, wherein the plurality of authentication protocols include:
symmetric encryption; asymmetric encryption; public key infrastructure, PKI; SIM Trust; IoT SAFE; TLS; DTLS; and Generic Bootstrapping Architecture, GBA.

8. The method according to any previous claim further comprising the step of the device selecting the authentication method from a plurality of authentication methods available to the device before generating the request including data indicating the one or more steps of the selected authentication method.

9. An authentication system comprising:
one or more devices, wherein each of the one or more devices is configured to generate an authentication request, the authentication request including data indicating one or more steps of an authentication method; and
a distributed ledger having a plurality of nodes, wherein each of the plurality of nodes is configured to:
receive from one of the devices an authentication request indicating the one or more steps of the authentication method; and
authenticate the device following the one or more steps indicated by the data received from the device.

10. The authentication system of claim 9, wherein a further device of the one or more devices is configured to generate a further authentication request indicating further one or more steps of a second authentication method different to the one or more steps of the authentication method.

11. The authentication system of claim 9 or claim 10, wherein authentication of the device is unsuccessful unless more than one node of the plurality of nodes authenticate the device according to the one or more steps indicated by the data received from the device.

12. The authentication system according to any of claims 9 to 11, wherein each of the one or more devices is further configured to select the authentication method from a plurality of authentication methods available to the device before generating the request including data indicating the one or more steps of the selected authentication method.

13. The authentication system according to any of claims 9 to 12, where each of the one or more devices is further configured to receive data defining a new authentication method for use in further authentication requests.

14. The authentication system of claim 13, wherein the original and/or new authentication method has an expiry time.

15. The authentication system according to any of claims 9 to 14, wherein the one or more devices further comprises a UICC or SIM configured to secure the request.
